(19) United States
(12) Patent Application Publication
(10) Pub. No.: US 2022/0222293 A1
(43) Pub. Date: Jul. 14, 2022

(54) SEARCH METHOD, SEARCH DEVICE, AND SEARCH SYSTEM

(71) Applicant: SEMICONDUCTOR ENERGY LABORATORY CO., LTD., ATSUGI-SHI, KANAGAWA-KEN (JP)

(72) Inventors: Hiromichi GODO, Isehara, Kanagawa (JP); Takahiro FUKUTOME, Atsugi, Kanagawa (JP); Satoru OKAMOTO, Isehara, Kanagawa (JP)

(21) Appl. No.: 17/610,183

(22) PCT Filed: Apr. 30, 2020
(86) PCT No.: PCT/IB2020/054055

§ 371 Date: Nov. 10, 2021

(30) Foreign Application Priority Data
May 15, 2019 (JP) 2019-092100

(51) Int. Cl. G06F 16/58; G06F 16/538; G06F 30/39

(52) U.S. Cl. CPC G06F 16/5866; G06F 30/39; G06F 16/538

(57) ABSTRACT

A search system and a search method are provided. The search system includes a means to input first circuit diagram information to a terminal, a database in which second circuit diagram information is registered, a means to convert the input first circuit diagram information into a first graph, an arithmetic means to calculate similarity between the first graph and a second graph based on the second circuit diagram information, and a means to display the similarity on the terminal.

### TECHNICAL FIELD

One embodiment of the present invention relates to a search method, a search device, and a search system. In particular, one embodiment of the present invention relates to a method, a device, and a system for searching for a circuit diagram and text related to a circuit diagram.

### BACKGROUND ART

In a data processing field, a data structure called a graph has been proposed. A graph consists of a set of vertices (nodes) and sides (edges), and is used as a means to express a network structure, such as connection between people in the community or a transportation network, for example (Patent Document 1).

A number of methods for analyzing graphs theoretically have been proposed so far. For example, Non-Patent Document 1 has disclosed a method for calculating similarity between graphs.

### REFERENCES

### Patent Document

[Patent Document 1] Japanese Published Patent Application No. 2016-119082

### Non-Patent Document

[Non-Patent Document 1] Nino Shervashidze, et al., Journal of Machine Learning Research 12, pp. 2539-2561, 2011

### SUMMARY OF THE INVENTION

### Problems to be Solved by the Invention

There is much demand for searching for a drawing stored in a computer, server, or the like, a drawing written in a document, or text describing a drawing (also referred to as text information). Here, document examples include a patent gazette, a paper, and the like. In addition, drawing examples include a circuit diagram such as an electronic circuit diagram. However, a currently accessible common method for searching for a drawing cannot take connection information of circuit elements into consideration. Accordingly, a machine cannot find a network circuit diagram by a search method or the like using a search query, and a human visually searches for the network circuit diagram in the end.

An object of one embodiment of the present invention is to provide a method for searching for a circuit diagram. Another object of one embodiment of the present invention is to provide a device for searching for a circuit diagram. Another object of one embodiment of the present invention is to provide a system for searching for a circuit diagram. Another object of one embodiment of the present invention is to provide a method for searching for text describing a circuit diagram. Another object of one embodiment of the present invention is to provide a device for searching for text describing a circuit diagram. Another object of one embodiment of the present invention is to provide a system for searching for text describing a circuit diagram.

### Means for Solving the Problems

One embodiment of the present invention is a search system that includes a means to input first circuit diagram information to a terminal, a database in which second circuit diagram information is registered, a means to convert the input first circuit diagram information into a first graph, an arithmetic means to calculate similarity between the first graph and a second graph based on the second circuit diagram information, and a means to display the similarity on the terminal.

In the above, it is preferable that the search system include a server connected to the terminal via a network and that the database be stored in the server.

In the above, it is preferable that the first circuit diagram information be a circuit element included in a circuit diagram.

In the above, it is preferable that the first circuit diagram information be text describing a circuit diagram.

In addition, one embodiment of the present invention is a search method that includes a step of converting first circuit diagram information input to a terminal into a first graph; a step of calculating similarity between the first graph and a second graph registered in a database; and a step of displaying the similarity on the terminal.

In the above, it is preferable that the first circuit diagram information be a circuit element included in a circuit diagram.

In the above, it is preferable that the first circuit diagram information be text describing a circuit diagram.

### Effect of the Invention

One embodiment of the present invention can provide a method for searching for a circuit diagram. Alternatively, one embodiment of the present invention can provide a device for searching for a circuit diagram. Alternatively, one embodiment of the present invention can provide a system for searching for a circuit diagram. Alternatively, one embodiment of the present invention can provide a method for searching for text describing a circuit diagram. Alternatively, one embodiment of the present invention can provide a device for searching for text describing a circuit diagram. Alternatively, one embodiment of the present invention can provide a system for searching for text describing a circuit diagram.

### BRIEF DESCRIPTION OF THE DRAWINGS

FIG. 1A1 to FIG. 1F2 illustrate circuit elements and graphs corresponding to the circuit elements and are diagrams illustrating one embodiment of the present invention.

FIG. 2A1 to FIG. 2F2 illustrate circuit elements and graphs corresponding to the circuit elements and are diagrams illustrating one embodiment of the present invention.

FIG. 3A1 to FIG. 3G2 illustrate circuit elements and graphs corresponding to the circuit elements and are diagrams illustrating one embodiment of the present invention.

FIG. 4A and FIG. 4B illustrate a circuit diagram and a graph corresponding to the circuit diagram and are diagrams illustrating one embodiment of the present invention.

FIG. 5A and FIG. 5B illustrate a circuit diagram and a graph corresponding to the circuit diagram and are diagrams illustrating one embodiment of the present invention.

FIG. 6A and FIG. 6B illustrate a circuit diagram and a graph corresponding to the circuit diagram and are diagrams illustrating one embodiment of the present invention.

FIG. 7A and FIG. 7B are schematic diagrams illustrating a method for operating a terminal used for circuit diagram search according to one embodiment of the present invention.

FIG. 8A is a schematic diagram illustrating a method for operating the terminal used for the circuit diagram search according to one embodiment of the present invention. FIG. 8B and FIG. 8C are examples of circuit diagrams according to one embodiment of the present invention.

FIG. 9 is a schematic diagram illustrating the terminal according to one embodiment of the present invention.

FIG. 10 is a schematic diagram illustrating a network used for the circuit diagram search according to one embodiment of the present invention.

FIG. 11A1 to FIG. 11E2 are diagrams each illustrating a method for calculating similarity between graphs according to one embodiment of the present invention.

FIG. 12 is a flow chart showing one embodiment of the present invention.

FIG. 13 is a flow chart showing one embodiment of the present invention.

FIG. 14A and FIG. 14B are schematic diagrams illustrating a method for operating the terminal used for the circuit diagram search according to one embodiment of the present invention.

FIG. 15 is a diagram illustrating one example of the present invention.

FIG. 16A to FIG. 16D are diagrams illustrating one example of the present invention.

### MODE FOR CARRYING OUT THE INVENTION

### Embodiment 1

In this embodiment, a search system according to one embodiment of the present invention will be described. In a search system according to this embodiment, a circuit diagram and text describing a circuit diagram can be searched for.

Note that in this specification, a graph refers to a data structure that consists of vertices (nodes) and sides (edges) and expresses data connection. Graph examples include a digraph made in consideration of an edge direction and an undirected graph made without consideration of an edge direction. Unless otherwise noted, an undirected graph is dealt with in this specification.

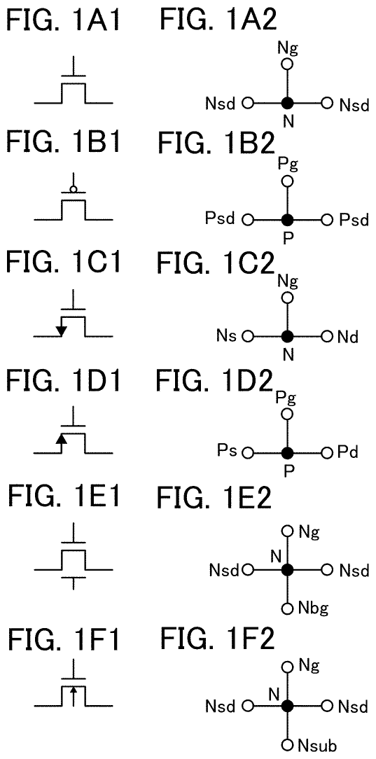

FIG. 1A1 illustrates a circuit symbol of an NMOS transistor, and FIG. 1A2 illustrates a graph corresponding to the circuit symbol. The graph in FIG. 1A2 is composed of one node N, two nodes Nsd, and one node Ng. The node Ng indicates a gate, and the node Nsd indicates a source or a drain. Each of the nodes Ng and Nsd is connected to the node N.

In this specification, a node shown by a black circle is referred to as an element node, which indicates an element center. In addition, a node shown by a white circle is referred to as a terminal node, which indicates an element terminal. For example, in FIG. 1A2, the node N is an element node and the nodes Ng and Nsd are terminal nodes. Usually, a plurality of terminal nodes are connected to one element node.

FIG. 1B1 illustrates a circuit symbol of a PMOS transistor, and FIG. 1B2 illustrates a graph corresponding to the circuit symbol. The graph in FIG. 1B2 is composed of one node P, two nodes Psd, and one node Pg. The node Pg indicates a gate, and the node Psd indicates a source or a drain. The node P is an element node, and each of the nodes Pg and Psd is a terminal node that is connected to the node P.

FIG. 1C1 illustrates a circuit symbol of an NMOS transistor, and FIG. 1C2 illustrates a graph corresponding to the circuit symbol. The NMOS transistor illustrated in FIG. 1C1 is used in the case where a source and a drain are distinguished from each other (a terminal indicated by an arrow is a source). The graph in FIG. 1C2 is composed of one node N, one node Ng, one node Ns, and one node Nd. The node Ng indicates a gate, the node Ns indicates a source, and the node Nd indicates a drain. The node N is an element node, and each of the nodes Ng, Ns, and Nd is a terminal node that is connected to the node N.

FIG. 1D1 illustrates a circuit symbol of a PMOS transistor, and FIG. 1D2 illustrates a graph corresponding to the circuit symbol. The PMOS transistor illustrated in FIG. 1D1 is used in the case where a source and a drain are distinguished from each other (a terminal indicated by an arrow is a source). The graph in FIG. 1D2 is composed of one node P, one node Pg, one node Ps, and one node Pd. The node Pg indicates a gate, the node Ps indicates a source, and the node Pd indicates a drain. The node P is an element node, and each of the nodes Pg, Ps, and Pd is a terminal node that is connected to the node P.

FIG. 1E1 illustrates a circuit symbol of an NMOS transistor including two gate electrodes, and FIG. 1E2 illustrates a graph corresponding to the circuit symbol. The graph in FIG. 1E2 is composed of one node N, two nodes Nsd, one node Ng, and one node Nbg. The node Ng indicates a first gate (also referred to as a front gate). The node Nbg indicates a second gate (also referred to as a back gate). The node Nsd indicates a source or a drain. The node N is an element node, and each of the nodes Ng, Nbg, and Nsd is a terminal node that is connected to the node N.

Moreover, although not illustrated, a graph of a PMOS transistor including two gate electrodes can be defined similarly.

FIG. 1F1 illustrates a circuit symbol of an NMOS transistor to which a substrate potential can be applied, and FIG. 1F2 illustrates a graph corresponding to the circuit symbol. The graph in FIG. 1F2 is composed of one node N, two nodes Nsd, one node Ng, and one node Nsub. The node Ng indicates a gate. The node Nsub indicates a substrate to which a potential can be applied. The node Nsd indicates a source or a drain. The node N is an element node, and each of the nodes Ng, Nsub, and Nsd is a terminal node that is connected to the node N.

Moreover, although not illustrated, a graph of a PMOS transistor to which a substrate potential can be applied can be defined similarly.

In addition, information on a semiconductor material used for a MOS transistor channel can be included in a circuit diagram and a graph.

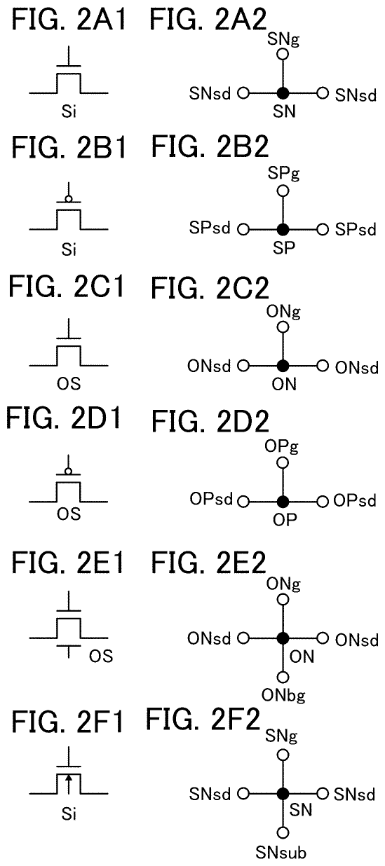

FIG. 2A1 illustrates a circuit symbol of an NMOS transistor using silicon for a channel, and FIG. 2A2 illustrates a graph corresponding to the circuit symbol. The graph in FIG. 2A2 is composed of one node SN, two nodes SNsd, and one node SNg. The node SNg indicates a gate, and the node SNsd indicates a source or a drain. The node SN is an element node, and each of the nodes SNg and SNsd is a terminal node that is connected to the node SN.

FIG. 2B1 illustrates a circuit symbol of a PMOS transistor using silicon for a channel, and FIG. 2B2 illustrates a graph corresponding to the circuit symbol. The graph in FIG. 2B2 is composed of one node SP, two nodes SPsd, and one node SPg. The node SPg indicates a gate, and the node SPsd indicates a source or a drain. The node SP is an element node, and each of the nodes SPg and SPsd is a terminal node that is connected to the node SP.

In addition, as a transistor semiconductor material, an oxide semiconductor (OS) can be used. In particular, a transistor using an OS in a channel formation region is preferable because leakage current in a non-conduction state is extremely low. Such a transistor can be used for a semiconductor device such as a display device, a projection device, a lighting device, an electro-optical device, a power storage device, a memory device, a semiconductor circuit, an imaging device, or an electronic device. Specific examples of the display device include a liquid crystal display device, a light-emitting display device, and the like. Furthermore, specific examples of the semiconductor circuit include LSI such as a CPU and a memory, an IC chip on which one or more of these are mounted, and the like. The transistor using an OS in a channel formation region has extremely low leakage current in a non-conduction state; thus, a semiconductor device with low power consumption can be provided.

An oxide containing at least one of indium (In), gallium (Ga), and zinc (Zn) can be used as the OS. For example, a metal oxide such as an In-M-Zn oxide (the element M is one kind or a plurality of kinds selected from aluminum, gallium, yttrium, tin, copper, vanadium, beryllium, boron, titanium, iron, nickel, germanium, zirconium, molybdenum, lanthanum, cerium, neodymium, hafnium, tantalum, tungsten, magnesium, and the like) is preferably used as the OS. It is particularly preferable that aluminum, gallium, yttrium, tin, or the like be contained in addition to indium and zinc. Furthermore, an In—Ga oxide or an In—Zn oxide may be used as the OS.

In addition, the OS preferably has a crystal structure. Examples of an OS having a crystal structure include a CAAC-OS (c-axis aligned crystalline oxide semiconductor), a polycrystalline oxide semiconductor, an nc-OS (nanocrystalline oxide semiconductor), and the like.

The CAAC-OS has c-axis alignment, a plurality of nanocrystals are connected in the a-b plane direction, and its crystal structure has distortion. Note that the distortion refers to a portion where the direction of lattice arrangement changes between a region with regular lattice arrangement and another region with regular lattice arrangement in a region where the plurality of nanocrystals are connected.

The nanocrystal is basically a hexagon but is not always a regular hexagon and is a non-regular hexagon in some cases. Furthermore, pentagonal lattice arrangement, heptagonal lattice arrangement, and the like are included in the distortion in some cases. Note that it is difficult to observe a clear crystal grain boundary (also referred to as grain boundary) even in the vicinity of distortion in the CAAC-OS. That is, formation of a crystal grain boundary is inhibited by the distortion of lattice arrangement. This is probably because the CAAC-OS can tolerate distortion owing to the low density of oxygen atom arrangement in the a-b plane direction, a change in interatomic bond distance by replacement of a metal element, and the like.

Furthermore, the CAAC-OS tends to have a layered crystal structure (also referred to as a layered structure) in which a layer containing indium and oxygen (hereinafter referred to as an In layer) and a layer containing the element M, zinc, and oxygen (hereinafter referred to as an (M,Zn) layer) are stacked. Note that indium and the element M can be replaced with each other, and when the element Min the (M,Zn) layer is replaced with indium, the layer can also be referred to as an (In,M,Zn) layer. Furthermore, when indium in the In layer is replaced with the element M, the layer can be referred to as an (In,M) layer.

The CAAC-OS is a metal oxide with high crystallinity. Meanwhile, it can be said that a reduction in electron mobility due to the crystal grain boundary is less likely to occur because a clear crystal grain boundary is difficult to observe in the CAAC-OS. Furthermore, the mixing of impurities, formation of defects, or the like might decrease the crystallinity of the metal oxide; thus, it can also be said that the CAAC-OS is a metal oxide having small amounts of impurities and defects (oxygen vacancies (also referred to as Vo) or the like). Thus, a metal oxide including a CAAC-OS is physically stable. Therefore, the metal oxide including a CAAC-OS is resistant to heat and has high reliability.

In the nc-OS, a microscopic region (for example, a region with a size greater than or equal to 1 nm and less than or equal to 10 nm, in particular, a region with a size greater than or equal to 1 nm and less than or equal to 3 nm) has periodic atomic arrangement. Furthermore, there is no regularity of crystal orientation between different nanocrystals in the nc-OS. Thus, the orientation in the whole film is not observed. Accordingly, the nc-OS cannot be distinguished from an a-like OS or an amorphous oxide semiconductor depending on the analysis method.

Note that indium-gallium-zinc oxide (hereinafter referred to as IGZO), which is a kind of metal oxide containing indium, gallium, and zinc, has a stable structure in some cases by being formed of the nanocrystals. In particular, crystals of IGZO tend not to grow in the air; thus, a stable structure is obtained in some cases when IGZO is formed of smaller crystals (e.g., the nanocrystals) rather than larger crystals (here, crystals with a size of several millimeters or several centimeters).

Alternatively, the OS may be an amorphous-like oxide semiconductor (a-like OS) or an amorphous oxide semiconductor.

The a-like OS is a metal oxide that has a structure between those of the nc-OS and the amorphous oxide semiconductor. The a-like OS includes a void or a low-density region. That is, the a-like OS has lower crystallinity than the nc-OS and the CAAC-OS.

An OS has various structures with different properties. Two or more kinds of the amorphous oxide semiconductor, the polycrystalline oxide semiconductor, the a-like OS, the nc-OS, and the CAAC-OS may be included in an OS of one embodiment of the present invention.

FIG. 2C1 illustrates a circuit symbol of an NMOS transistor using an OS for a channel, and FIG. 2C2 illustrates a graph corresponding to the circuit symbol. The graph in FIG. 2C2 is composed of one node ON, two nodes ONsd, and one node ONg. The node ONg indicates a gate, and the node ONsd indicates a source or a drain. The node ON is an element node, and each of the nodes ONg and ONsd is a terminal node that is connected to the node ON.

FIG. 2D1 illustrates a circuit symbol of a PMOS transistor using an OS for a channel, and FIG. 2D2 illustrates a graph corresponding to the circuit symbol. The graph in FIG. 2D2 is composed of one node OP, two nodes OPsd, and one node OPg. The node OPg indicates a gate, and the node OPsd indicates a source or a drain. The node OP is an element node, and each of the nodes OPg and OPsd is a terminal node that is connected to the node OP.

FIG. 2E1 illustrates a circuit symbol of an NMOS transistor that uses an OS for a channel and includes two gate electrodes, and FIG. 2E2 illustrates a graph corresponding to the circuit symbol. The graph in FIG. 2E2 is composed of one node ON, two nodes ONsd, one node ONg, and one node ONbg. The node ONg indicates a first gate (also referred to as a front gate). The node ONbg indicates a second gate (also referred to as a back gate). The node ONsd indicates a source or a drain. The node ON is an element node, and each of the nodes ONg, ONbg, and ONsd is a terminal node that is connected to the node ON.

FIG. 2F1 illustrates a circuit symbol of an NMOS transistor using silicon for a channel to which a substrate potential can be applied, and FIG. 2F2 illustrates a graph corresponding to the circuit symbol. The graph in FIG. 2F2 is composed of one node SN, two nodes SNsd, one node SNg, and one node SNsub. The node SNg indicates a gate. The node SNsub indicates a substrate to which a potential can be applied. The node SNsd indicates a source or a drain. The node SN is an element node, and each of the nodes SNg, SNsub, and SNsd is a terminal node that is connected to the node SN.

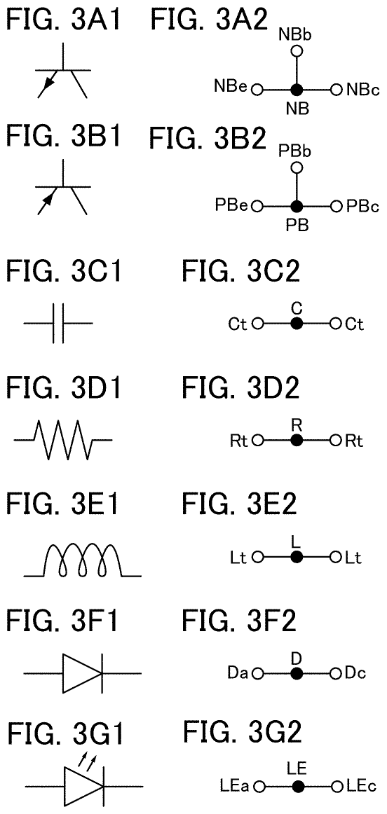

FIG. 3A1 illustrates a circuit symbol of an NPN type bipolar transistor, and FIG. 3A2 illustrates a graph corresponding to the circuit symbol. The graph in FIG. 3A2 is composed of one node NB, one node NBb, one node NBe, and one node NBc. The node NBb indicates a base, the node NBe indicates an emitter, and the node NBc indicates a collector. The node NB is an element node, and each of the nodes NBb, NBe, and NBc is a terminal node that is connected to the node NB.

FIG. 3B1 illustrates a circuit symbol of a PNP type bipolar transistor, and FIG. 3B2 illustrates a graph corresponding to the circuit symbol. The graph in FIG. 3B2 is composed of one node PB, one node PBb, one node PBe, and one node PBc. The node PBb indicates a base, the node PBe indicates an emitter, and the node PBc indicates a collector. The node PB is an element node, and each of the nodes PBb, PBe, and PBc is a terminal node that is connected to the node PB.

FIG. 3C1 illustrates a circuit symbol of a capacitor, and FIG. 3C2 illustrates a graph corresponding to the circuit symbol. The graph in FIG. 3C2 is composed of one node C and two nodes Ct. The node C is an element node, and the node Ct is a terminal node that is connected to the node C.

FIG. 3D1 illustrates a circuit symbol of a resistor, and FIG. 3D2 illustrates a graph corresponding to the circuit symbol. The graph in FIG. 3D2 is composed of one node R and two nodes Rt. The node R is an element node, and the node Rt is a terminal node that is connected to the node R.

FIG. 3E1 illustrates a circuit symbol of an inductor, and FIG. 3E2 illustrates a graph corresponding to the circuit symbol. The graph in FIG. 3E2 is composed of one node L and two nodes Lt. The node L is an element node, and the node Lt is a terminal node that is connected to the node L.

FIG. 3F1 illustrates a circuit symbol of a diode, and FIG. 3F2 illustrates a graph corresponding to the circuit symbol. The graph in FIG. 3F2 is composed of one node D, one node Da, and one node Dc. The node Da indicates an anode, and the node Dc indicates a cathode. The node D is an element node, and the nodes Da and Dc are terminal nodes that are connected to the node D.

FIG. 3G1 illustrates a circuit symbol of a light-emitting diode, and FIG. 3G2 illustrates a graph corresponding to the circuit symbol. The graph in FIG. 3G2 is composed of one node LE, one node LEa, and one node LEc. The node LEa indicates an anode, and the node LEc indicates a cathode. The node LE is an element node, and the nodes LEa and LEc are terminal nodes that are connected to the node LE.

As described above, a graph illustrating a circuit element can be defined by an “element node” and “terminal nodes.” The number of element nodes is one, and there are as many terminal nodes as the number of terminals of the element. Graphs of other circuit symbols that are not illustrated in FIG. 1A1 to FIG. 3G2 can also be defined in a similar way of thinking.

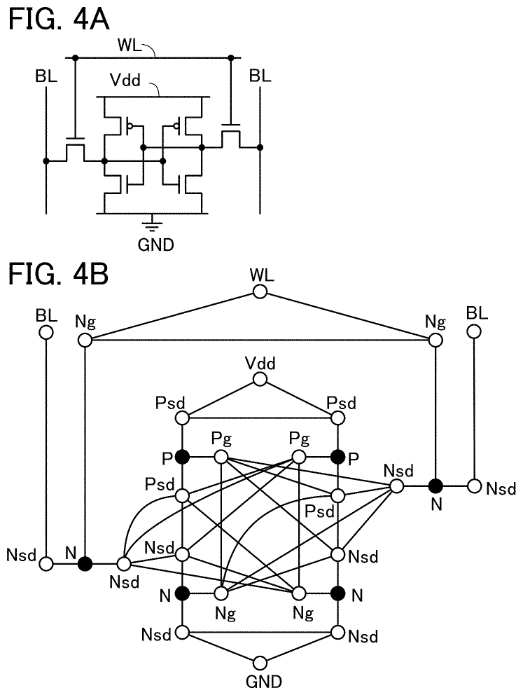

FIG. 4A illustrates a circuit diagram of an SRAM (Static Random Access Memory) formed using CMOS transistors, and FIG. 4B illustrates a graph corresponding to the circuit diagram. Note that in the graph in FIG. 4B, some edges are indicated by curves for clarity.

The SRAM in FIG. 4A is composed of four NMOS transistors, two PMOS transistors, a wiring WL, two wirings BL, a power supply line (Vdd), and GND. Note that to one of the two wirings BL, an inverted signal of a signal of the other is input.

The graph in FIG. 4B is composed of the graphs illustrated in FIG. 1A2 and FIG. 1B2 and terminal nodes indicating wirings such as the wiring WL and the wiring BL. All the terminal nodes at the same potential share edges. Note that in the graph in FIG. 4B, wirings such as the wiring WL and the wiring BL are provided as needed or may be omitted if unnecessary.

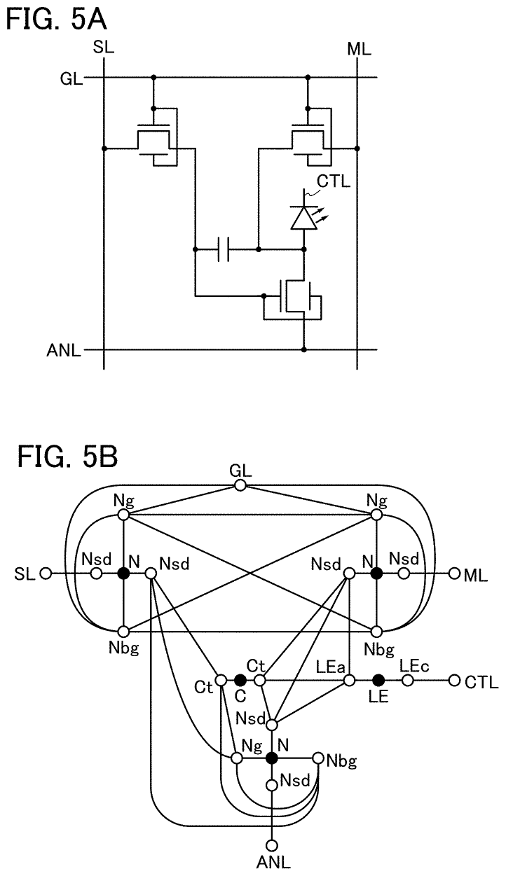

FIG. 5A illustrates a pixel circuit of an organic EL display, and FIG. 5B illustrates a graph corresponding to the pixel circuit. Note that in the graph in FIG. 5B, some edges are indicated by curves for clarity.

The pixel circuit in FIG. 5A is composed of three NMOS transistors, one capacitor, one light-emitting diode (OLED), a scan line GL, a signal line SL, a monitor line ML, an anode ANL, and a cathode CTL. Note that the three NMOS transistors each include a first gate and a second gate.

The graph in FIG. 5B is composed of the graphs illustrated in FIG. 1E2, FIG. 3C2, and FIG. 3G2 and terminal nodes indicating wirings such as the scan line GL and the signal line SL. In addition, as in FIG. 4B, all the terminal nodes at the same potential share edges. Note that in the graph in FIG. 5B, wirings such as the scan line GL, the signal line SL, and the monitor line ML are provided as needed or may be omitted if unnecessary.

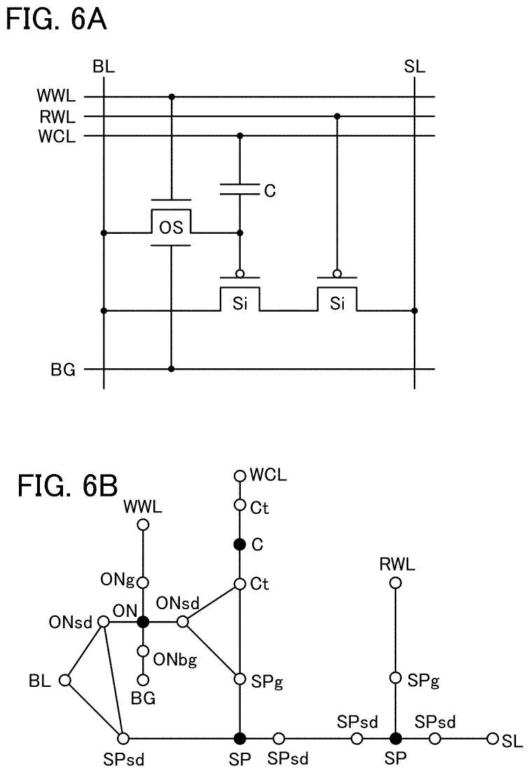

FIG. 6A is a circuit diagram of a memory cell using an OS transistor. The memory cell is a nonvolatile memory utilizing low off-state current of the OS transistor and is referred to as a NOSRAM (registered trademark, Nonvolatile Oxide Semiconductor RAM).

The NOSRAM in FIG. 6A is composed of an OS transistor including one back gate, two Si-PMOS transistors, a capacitor C, the wiring BL, a wiring SL, a wiring WWL, a wiring RWL, a wiring WCL, and a wiring BG.

The graph in FIG. 6B is composed of the graphs illustrated in FIG. 2B2, FIG. 2E2, and FIG. 3C2 and terminal nodes indicating wirings such as the wiring BL and the wiring SL. In addition, as in FIG. 4B and FIG. 5B, all the terminal nodes at the same potential share edges. Note that in the graph in FIG. 6B, wirings such as the wiring BL, the wiring SL, the wiring WWL, the wiring RWL, the wiring WCL, and the wiring BG are provided as needed or may be omitted if unnecessary.

Even in the case where the OS transistor and the Si transistors coexist in the same circuit in this manner, features of the circuit can be expressed in the graph when these transistors are distinguished from each other in the graph.

Note that when a circuit diagram is illustrated in a graph, not all the wirings are necessarily illustrated in the graph. For example, only wirings that show the features of the circuit are illustrated in the graph. In FIG. 4B, not all the wiring WL, the wiring BL, the power supply line Vdd, and GND are required to be illustrated in the graph. Only some of them may be illustrated in the graph or they do not have to be illustrated in the graph. In FIG. 5B, not all the scan line GL, the signal line SL, the monitor line ML, the anode ANL, and the cathode CTL are required to be illustrated in the graph. Only some of them may be illustrated in the graph or they do not have to be illustrated in the graph. In FIG. 6B, not all the wiring BL, the wiring SL, the wiring WWL, the wiring RWL, the wiring WCL, and the wiring BG are required to be illustrated in the graph. Only some of these wirings may be illustrated in the graph or these wirings do not have to be illustrated in the graph.

The above is the description of the method for expressing a circuit diagram by a graph. Next, a search device and a search system according to one embodiment of the present invention each using the graph will be described.

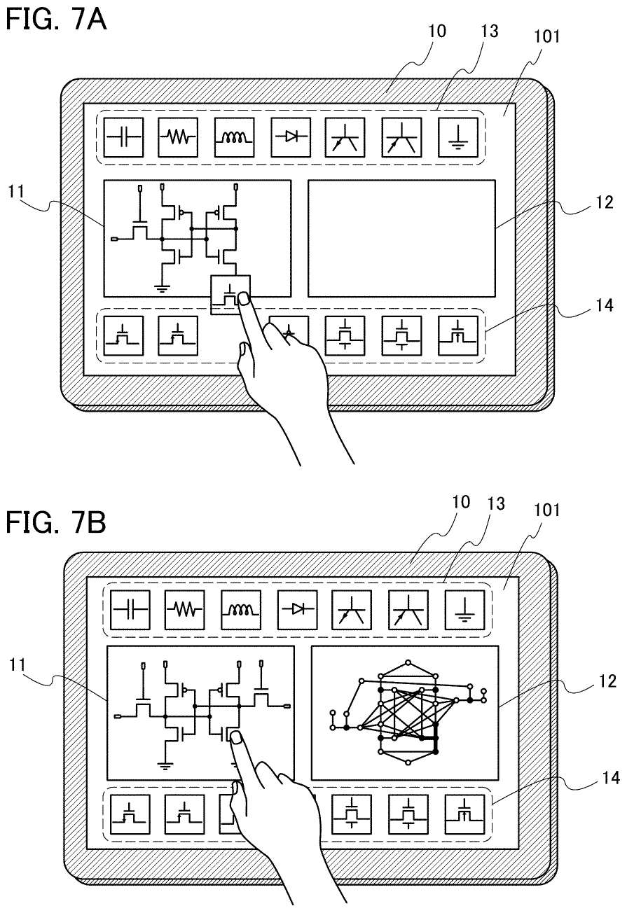

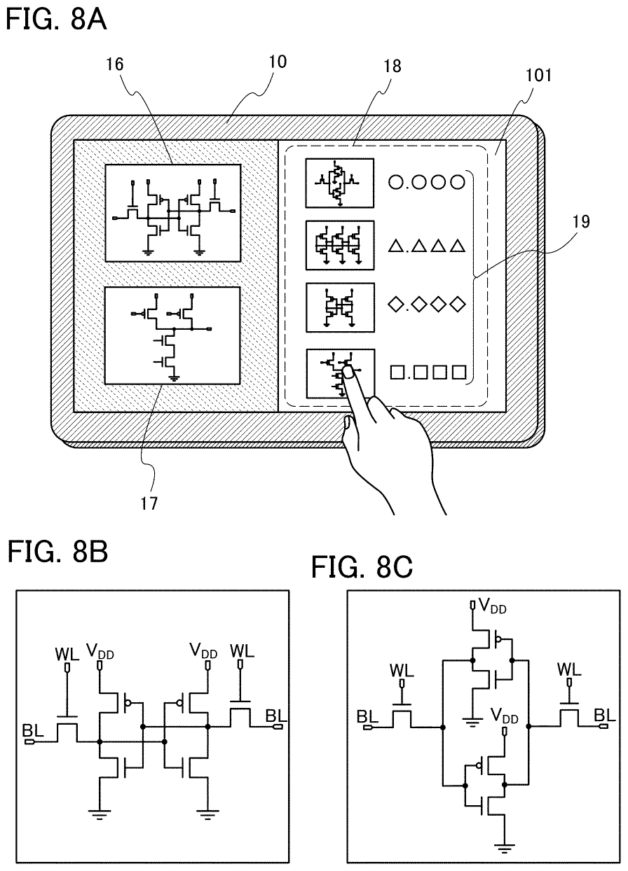

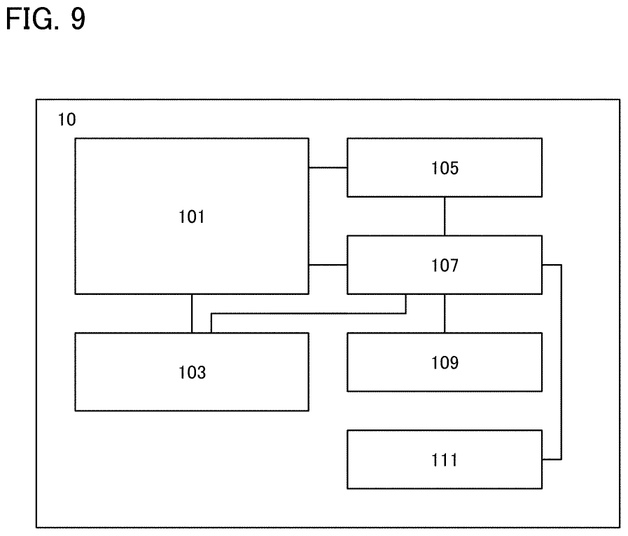

A terminal 10 illustrated in FIG. 7A, FIG. 7B, and FIG. 8A is an example of a search device that has functions of searching for a circuit diagram close to a circuit diagram input by a user from circuit diagrams registered in a database and displaying a result. In addition, FIG. 9 is a block diagram illustrating a structure example of the terminal 10. As illustrated in FIG. 9, the terminal 10 includes a display portion 101, an input portion 103, a processing portion 105, an arithmetic portion 107, a memory portion 109, and an external connection circuit 111. The display portion 101 is preferably a touch panel display. Note that the arithmetic portion 107 may also function as the processing portion 105. Furthermore, FIG. 8B and FIG. 8C each illustrate an example of a circuit diagram to be displayed on the display portion 101 of the terminal 10.

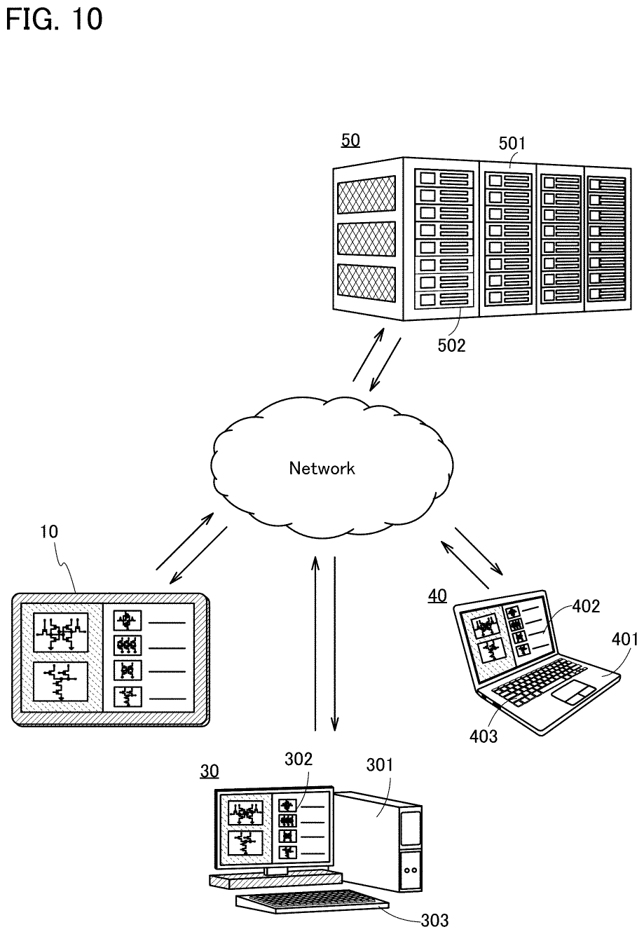

A plurality of circuit diagrams and graphs corresponding to the circuit diagrams are registered in advance in the database as circuit diagram information. In addition, text describing the circuit diagrams may be registered in the database. The database may be stored in the memory portion 109 incorporated in the terminal 10 or may be stored in an external memory device that is connected to the terminal 10. Alternatively, the database may be stored in a server 50 that is connected to the terminal 10 via a network, as illustrated in FIG. 10. The terminal 10 can be connected to the network by using the external connection circuit 111.

Here, examples of the network include a local area network (LAN), the Internet, and the like. In addition, either one or both wired and wireless communications can be used for the network. Furthermore, in the case where a wireless communication is used for the network, besides near field communication means such as Wi-Fi (registered trademark) and Bluetooth (registered trademark), a variety of communication means such as the third generation mobile communication system (3G)-compatible communication means, LTE (sometimes also referred to as 3.9G)-compatible communication means, the fourth generation mobile communication system (4G)-compatible communication means, or the fifth generation mobile communication system (5G)-compatible communication means can be used.

Note that although an example in which a tablet computer is used as the terminal 10 is illustrated, this embodiment is not limited thereto. FIG. 10 illustrates an example in which a desktop computer is used as a terminal 30 and a laptop computer is used as a terminal 40. The terminal 30 includes a main body 301, a display portion 302, and an input portion 303. The terminal 40 includes a main body 401, a display portion 402, and an input portion 403. The terminal 30 and the terminal 40 each preferably include a processing portion, an arithmetic portion, a memory portion, and an external connection circuit that correspond to the processing portion 105, the arithmetic portion 107, the memory portion 109, and the external connection circuit 111 in the terminal 10, respectively. The server 50 includes a rack 501 and a plurality of rack-mount computers 502. A database is stored in a memory device provided in the computer 502. Each of the terminal 30 and the terminal 40 has a function similar to that of the terminal 10 and is connected to the server 50 via the network. The terminal 10, the terminal 30, and the terminal 40 can access the database stored in the computer 502 of the server 50.

FIG. 7A and FIG. 7B each illustrate an example in which the user inputs a circuit diagram to be searched for to the terminal 10. A region 11 and a region 12 are displayed on the display portion 101 of the terminal 10, and the user creates a circuit diagram to be searched for in the region 11. A region 13 and a region 14 are located above and below the region 11 and the region 12. Circuit elements that constitute the circuit diagram are provided in the region 13 and the region 14. The terminal 10 is provided with an input means such as a touch panel display, a keyboard, or a mouse, and the user can create a desired circuit diagram by dragging and dropping each circuit element on the region 11 (FIG. 7A).

After the user finishes inputting the circuit diagram to the region 11, a graph corresponding to the circuit diagram input to the region 11 is created by the terminal 10 or the processing portion 105 that is incorporated in the server 50 connected to the terminal 10 via the network. Note that the graph may be created by the arithmetic portion 107. The created graph is displayed on the region 12. In addition, when the user touches any one of the circuit elements in the region 11, colors of nodes and edges of the graph in the region 12 that corresponds to the elements touched by the user are changed (FIG. 7B). Accordingly, the user can confirm correspondence between the circuit diagram created by the user and the graph generated by the terminal 10.

Note that the terminal 10 can treat a netlist instead of a circuit diagram as input data. A netlist is a text file that describes connection information on circuit elements. The terminal 10 can convert a netlist into a graph.

In addition, the terminal 10 can also directly treat a graph as input data.

Furthermore, the terminal 10 can treat image data in which a circuit diagram is drawn as input data. The terminal 10 can read connection information on circuit elements from the image data and can generate a graph.

Next, similarity between a graph displayed on the region 12 and a graph registered in the database is calculated. For calculation of the similarity between the graphs, a label histogram kernel method, a random walk kernel method, a WL (Weisfeiler-Lehman) kernel method, a GNN (Graph Neural Network), or the like is used. In particular, a method using a WL kernel method is preferable because of high accuracy and short calculation time.

### <Description of WL Kernel>

Here, a WL kernel method, which is one of the methods for calculating similarity between graphs, is described using simple circuits.

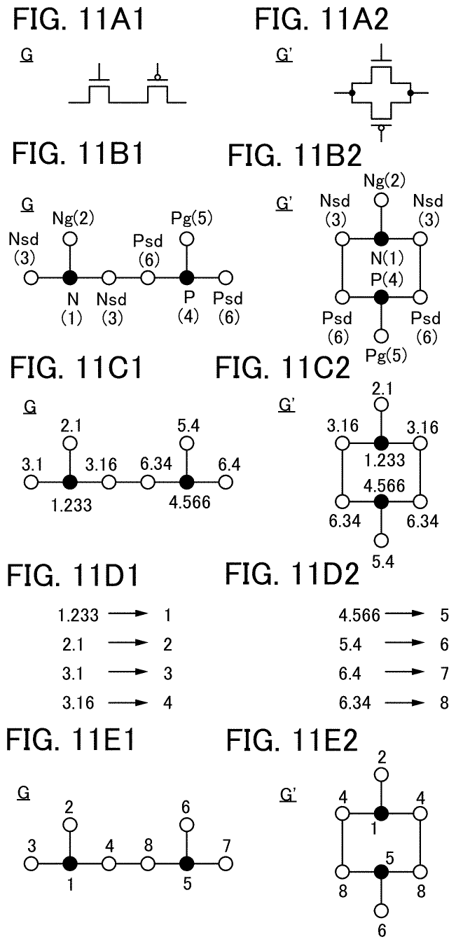

A circuit G illustrated in FIG. 11A1 is a circuit in which an NMOS transistor and a PMOS transistor are connected in series. In addition, a circuit G′ illustrated in FIG. 11A2 is a circuit in which an NMOS transistor and a PMOS transistor are connected in parallel. A method for calculating similarity between these two circuits is described below.

First, the circuits G and G′ are illustrated in graphs by using the above method. FIG. 11B1 is a graph illustrating the circuit G, and FIG. 11B2 is a graph illustrating the circuit G′. Labels (numbers) are assigned to nodes included in these graphs according to the kind of the node. In FIG. 11B1 and FIG. 11B2, numbers in parentheses correspond to the labels.

Next, the number of labels in each circuit is counted, and a feature vector of each circuit is generated. In Formula 1, ϕ(G) represents the feature vector of the circuit G. In Formula 2, ϕ(G′) represents the feature vector of the circuit G′.

$$\begin{matrix}ϕ ( G ) = ( 1 , 1 , 2 , 1 , 1 , 2 ) & ( Formula 1 ) \\ ϕ ( {G}^{′} ) = ( 1 , 1 , 2 , 1 , 1 , 2 ) & ( Formula 2 )\end{matrix}$$

For example, the right side of Formula 1 means that, starting from the left, there are one label of “1,” one label of “2,” two labels of “3,” one label of “4,” one label of “5,” and two labels of “6.” The same applies to Formula 2.

Next, the number of labels in adjacent nodes is counted (FIG. 11C1 and FIG. 11C2). For example, “1.233” in FIG. 11C1 means that an adjacent node with the label of “1” has one label of “2” and two labels of “3.” The same applies to other nodes.

Next, new labels are assigned to numerical values given in FIG. 11C1 and FIG. 11C2 (see FIG. 11D1 and FIG. 11D2).

Next, the labels assigned in FIG. 11D1 and FIG. 11D2 are assigned again to the circuits G and G′ (see FIG. 11E1 and FIG. 11E2). Note that a series of work shown in FIG. 11C1, FIG. 11D1, and FIG. 11E1 (or FIG. 11C2, FIG. 11D2, and FIG. 11E2) is referred to as re-labeling.

Next, the number of labels in the circuits G and G′ that are subjected to re-labeling is counted, and the feature vector of each circuit is calculated again. Formula 3 represents the feature vector of the circuit G, and Formula 4 represents the feature vector of the circuit G′.

$$\begin{matrix}ϕ ( G ) = ( 1 , 1 , 2 , 1 , 1 , 2 , 1 , 1 , 1 , 1 , 1 , 1 , 1 , 1 ) & ( Formula 3 ) \\ ϕ ( {G}^{′} ) = ( 1 , 1 , 2 , 1 , 1 , 2 , 1 , 1 , 0 , 2 , 1 , 1 , 0 , 2 ) & ( Formula 4 )\end{matrix}$$

For example, in the right side of Formula 3, starting from the left, first six terms are the same as those in Formula (1), and subsequent eight terms are added by re-labeling. The same applies to Formula 4.

When the re-labeling work is subsequently repeated a certain number of times, the feature vectors ϕ(G) and ϕ(G′) that represent features of the graphs more precisely are obtained. Finally, K_{WL} (referred to as a Gaussian kernel or an RBF kernel) represented by Formula 5 shown below is calculated, so that the similarity between the circuit G and the circuit G′ is calculated.

$$\begin{matrix}[ Formula 1 ] & \\ {K}_{WL} = exp ( - γ {‖ φ ( G ) - φ ( {G}^{′} ) ‖}^{2} ) & ( Formula 5 )\end{matrix}$$

The above is the method for calculating similarity between graphs by using the WL kernel method.

The similarity may be calculated by the arithmetic portion 107 such as a CPU or a GPU incorporated in the terminal 10 or may be calculated by an arithmetic means such as a CPU or a GPU incorporated in the server 50 connected to the terminal 10 via the network.

FIG. 8A illustrates an example in which search results are displayed on the display portion 101 of the terminal 10. A circuit diagram of a search query input by the user is displayed on a region 16 in the display portion 101, and a list of the search results is displayed on a region 18 in the display portion 101. Numerical values 19 in the region 18 show similarities. When the user touches any one of circuit diagrams displayed on the region 18, an enlarged view of the circuit diagram is displayed on a region 17. Accordingly, the user can confirm the search results.

For example, two circuit diagrams illustrated in FIG. 8B and FIG. 8C each represent an SRAM and represent equivalent circuits. However, in the case where a search system cannot understand circuit connection information, the search system recognize these two circuits as different drawings. In contrast, with the use of the above method, FIG. 8B and FIG. 8C can be replaced with the same graph, so that a search system according to the present invention can recognize these two as the same circuit diagram.

In addition, text describing the displayed circuit diagrams can also be displayed on the region 18. The user can compare input text information with a circuit diagram or text displayed on the terminal 10 while referring to the obtained similarity.

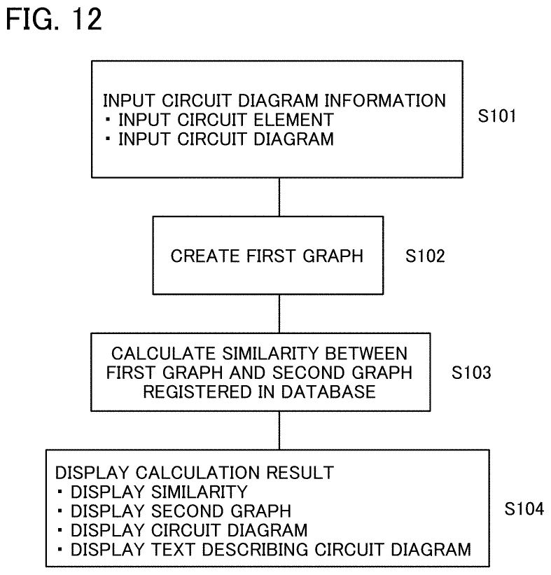

FIG. 12 is a flow chart showing one mode of a method for searching for a circuit diagram and text describing a circuit diagram according to the present invention.

First, circuit diagram information is input to the terminal 10 (S101). The user inputs circuit elements to the terminal 10 by using the input portion 103. In addition, a circuit diagram can be created using a plurality of circuit elements. Here, the input circuit elements and the created circuit diagram are referred to as the circuit diagram information.

Next, a graph is generated in the processing portion 105 from the input circuit diagram information (S102). Here, the generated graph is referred to as a first graph for convenience. The processing portion 105 preferably includes a second memory portion that temporarily stores the input circuit diagram information and a second arithmetic portion for generating the first graph. On the other hand, the input circuit diagram information may be temporarily stored in the memory portion 109. Furthermore, the first graph may be generated in the arithmetic portion 107.

Next, similarity between the first graph and a plurality of graphs registered in the database is calculated in the arithmetic portion 107 (S103). Here, the graph registered in the database is referred to as a second graph for convenience. Similarity between the first graph that is stored in the processing portion 105 or the memory portion 109 and the second graph is calculated in the arithmetic portion 107 by using a label histogram kernel method, a random walk kernel method, a WL kernel method, a GNN, or the like. Similarity between the first graph and each of the plurality of second graphs is calculated. As the similarity becomes higher, the second graph gets closer to the first graph.

In the case where the database is stored in the server 50 that is connected to the terminal 10 via the network, the terminal 10 can be connected to the network using the external connection circuit 111 and can access the database.

Alternatively, the above calculation may be performed in the server 50. In that case, data on the first graph is transmitted to the server 50 through the external connection circuit 111 and the network, and the similarity between the first graph and the second graph is calculated in the server 50. Calculation results are transmitted to the terminal 10 through the network and the external connection circuit 111.

Next, the calculation results, that is, search results are displayed on the display portion 101 (S104). The calculation results can be displayed in descending order of similarity. In addition, one or more of a graph, a circuit diagram, and text describing the circuit diagram that correspond to the similarity may be displayed at the same time as display of the similarity. Furthermore, the calculation results may be displayed in the order of the earliest or latest creation date of a circuit diagram and text describing a circuit diagram within a certain range of similarity.

The user can search for a desired circuit diagram or a circuit diagram that is similar to the desired circuit diagram from the plurality of circuit diagrams registered in the database, on the basis of the calculation results.

As described above, one embodiment of the present invention can provide a search method that can search for a circuit diagram and text describing a circuit diagram. Alternatively, one embodiment of the present invention can provide a search device that can search for a circuit diagram and text describing a circuit diagram. Alternatively, one embodiment of the present invention can provide a search system that can search for a circuit diagram and text describing a circuit diagram.

The composition, structure, method, and the like described in this embodiment can be used in an appropriate combination with the compositions, structures, methods, and the like described in the other embodiment and the example.

### Embodiment 2

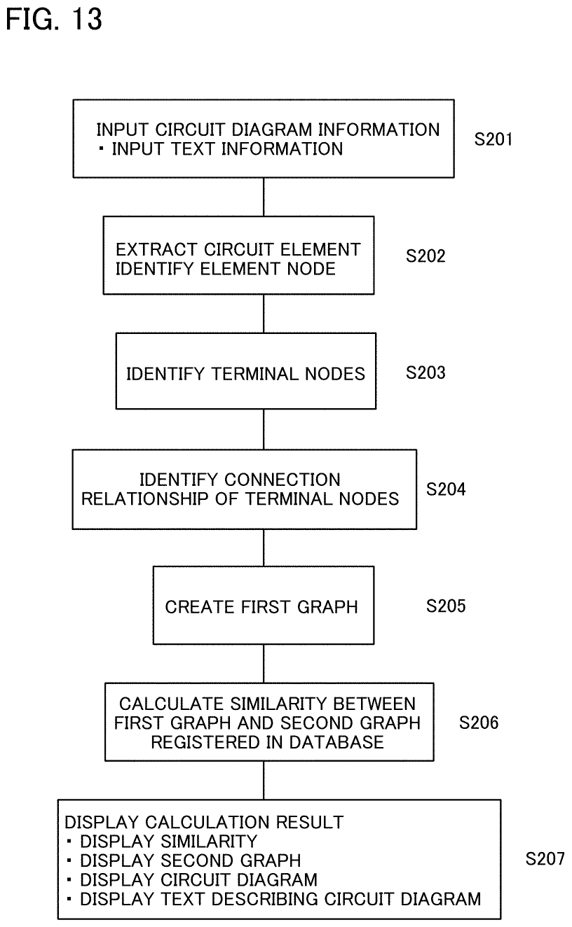

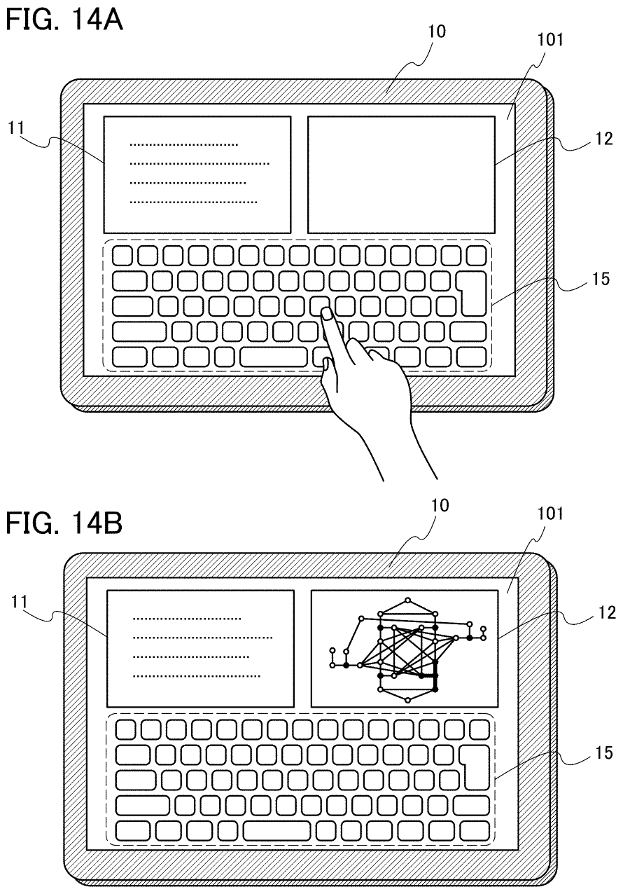

In this embodiment, a search system according to one embodiment of the present invention that is different from the above embodiment will be described using FIG. 13 and FIG. 14. In a search system according to this embodiment, text describing a circuit diagram, and a circuit diagram can be searched for.

In this embodiment, text information is illustrated in a graph and is compared with graph information registered in a database so that similarity is calculated. The text information includes circuit diagram information, that is, information on circuit elements and their connection relationship expressed in characters. Specific examples of the text information include text such as papers and patent specifications. In particular, in a patent specification, Mode for Carrying Out the Invention, Example, claims described in Scope of Claims, and the like correspond to the text information.

The text information is input to the terminal 10 as a search query (S201 in FIG. 13). For example, as illustrated in FIG. 14A, a keyboard or the like is displayed on a region 15 in the display portion 101 of the terminal 10 so that the text information can be input. The input text information is displayed on the region 11. Alternatively, the text information may be input by copying and pasting electronic data on text prepared by the user.

The terminal 10 or the server 50 that is connected to the terminal 10 via the network extracts a circuit element from the text information input to the terminal 10. Next, an element node is identified from the name of the circuit element (S202). In the case where extraction of the circuit element and identification of the element node are performed in the terminal 10, these processes can be performed by the processing portion 105.

Here, the circuit element refers to a transistor, a capacitor, a resistor, an inductor, a diode, a light-emitting diode, or the like.

Next, the terminal 10 or the server 50 identifies terminal nodes included in the circuit element (S203). The terminal nodes can be identified based on the text information input to the terminal 10 or information registered in the terminal 10 or the database included in the server 50.

Next, the connection relationship of the terminal nodes is identified from the text information input to the terminal 10 (S204).

An example sentence is described below. In the case where text information “A transistor and a capacitor are included, and a gate of the transistor is connected to a first terminal of the capacitor.” is input to the terminal 10, the terminal 10 or the server 50 identifies the transistor and the capacitor as element nodes. Information on inclusion of terminals corresponding to a gate, a source, and a drain in the transistor and information on inclusion of two terminals in the capacitor are registered in the terminal 10 or the database included in the server 50. Accordingly, the terminal 10 or the server 50 identifies at least three terminal nodes with respect to the element node of the transistor and two terminal nodes with respect to the element node of the capacitor.

Next, it is possible to identify connection relationship where the terminal node corresponding to the gate of the transistor is connected to one of the terminal nodes of the capacitor from the text information “The gate of the transistor is connected to the first terminal of the capacitor.”

Through the above method, the element nodes, the terminal nodes, and the connection relationship of each terminal node are identified by the terminal 10 or the server 50 from the text information.

Next, the circuit diagram information is illustrated in a graph from the obtained element nodes, the terminal nodes, and the connection relationship of each terminal node, and the first graph is created (S205). The obtained first graph can be displayed on the region 12 of the display portion 101, as illustrated in FIG. 14B.

After the graph illustration of the circuit diagram information is completed, similarity between the first graph and the second graph stored in the database is calculated as in the above embodiment (S206), and a calculation result can be displayed on the terminal 10 (S207).

In addition, graph data, text corresponding to the graph data, and a circuit diagram corresponding to the graph data may be registered in the database. When the similarity between the graphs is calculated and displayed on the terminal 10 as described above, either one or both text corresponding to the similarity and the circuit diagram may also be displayed. A method for displaying the similarity between the graphs, the text, and the circuit diagram can be selected by the user as appropriate.

In other words, input of text information allows the user to search for text or a circuit diagram that is similar to the text information.

The user can compare the input text information with the text or the circuit diagram displayed on the terminal 10 with reference to the obtained similarity.

As described above, one embodiment of the present invention can provide a search method that can search for a circuit diagram and text describing a circuit diagram. Alternatively, one embodiment of the present invention can provide a search device that can search for a circuit diagram and text describing a circuit diagram. Alternatively, one embodiment of the present invention can provide a search system that can search for a circuit diagram and text describing a circuit diagram.

The composition, structure, method, and the like described in this embodiment can be used in an appropriate combination with the compositions, structures, methods, and the like described in the other embodiment and the example.

### Example

In this example, an example is described in which similarity between circuit diagrams is actually calculated using the method described in Embodiment 1. Specifically, circuit diagrams were illustrated in graphs and similarity between the graphs was calculated using a WL (Weisfeiler-Lehman) kernel method.

### <Example of Similarity Calculation>

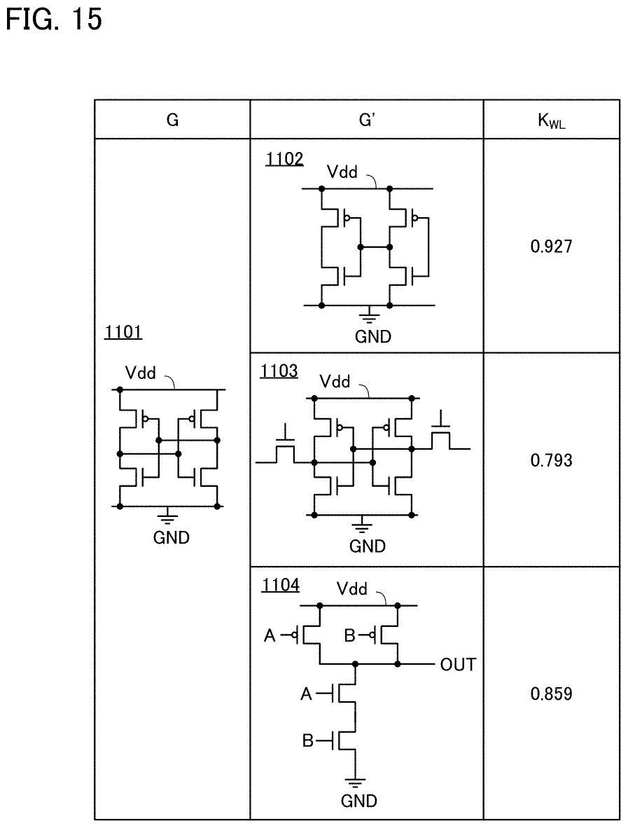

FIG. 15 is an example in which similarity (K_{WL}) between a circuit diagram G input as a query and a circuit diagram G′ to be compared is calculated using a WL kernel method. In other words, in FIG. 15, a circuit diagram 1101 is compared with each of a circuit diagram 1102, a circuit diagram 1103, and a circuit diagram 1104.

The circuit diagram 1101 is a circuit diagram in which CMOS inverters are connected in a loop. The circuit diagram 1102 is a circuit diagram in which two CMOS inverters are connected in series. The circuit diagram 1103 is an SRAM circuit diagram. The circuit diagram 1104 is a NAND gate circuit diagram.

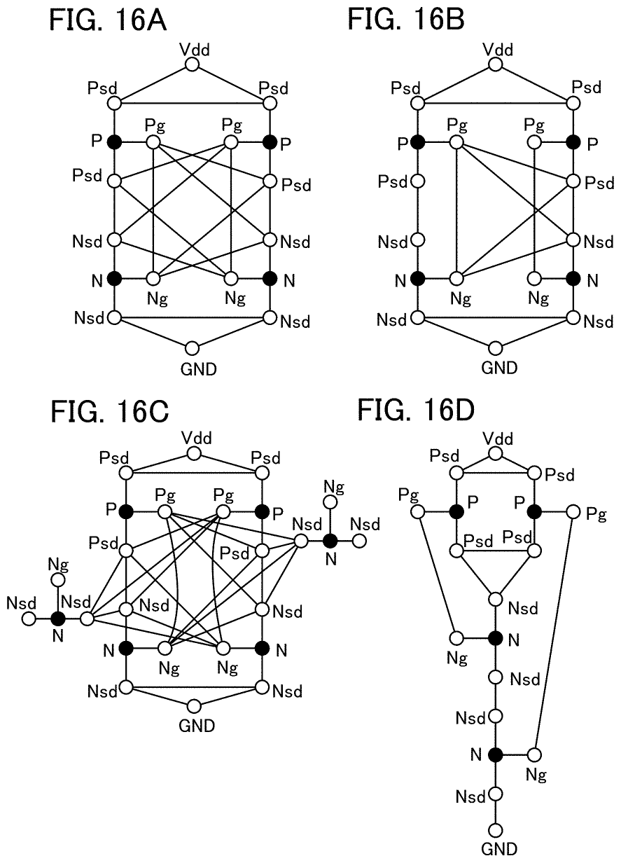

FIG. 16A to FIG. 16D are graphs each illustrating the circuit diagram illustrated in FIG. 15. FIG. 16A illustrates a graph of the circuit diagram 1101. FIG. 16B illustrates a graph of the circuit diagram 1102. FIG. 16C illustrates a graph of the circuit diagram 1103. FIG. 16D illustrates a graph of the circuit diagram 1104.

FIG. 15 is described again. K_{WL}, illustrated in FIG. 15 is a Gaussian kernel that is presented by Formula 5 and shows similarity between two circuit diagrams. As the value of K_{WL} gets closer to 1, the similarity between the two circuit diagrams becomes higher. Note that in K_{WL} calculation, yin Formula 5 was set to 0.001 and the number of times of iterations (the number of times of re-labelings) was set to 3.

Re-labeling calculation and K_{WL} calculation may be performed by the terminal 10 or may be performed by a server.

Results in FIG. 15 show that the circuit diagram 1102 has the highest similarity with the circuit diagram 1101, followed by the circuit diagram 1104 and the circuit diagram 1103 in this order. It has been confirmed that the similarity between the circuit diagrams can be calculated when the circuit diagrams are illustrated in graphs in this manner.

The composition, structure, method, and the like described in this example can be used in an appropriate combination with the compositions, structures, methods, and the like described in the other embodiment and the example.

### REFERENCE NUMERALS

10: terminal, 11: region, 12: region, 13: region, 14: region, 15: region, 16: region, 17: region, 18: region, 19: numerical value, 30: terminal, 40: terminal, 50: server, 101: display portion, 103: input portion, 105: processing portion, 107: arithmetic portion, 109: memory portion, 111: external connection circuit, 301: main body, 302: display portion, 303: input portion, 401: main body, 402: display portion, 403: input portion, 501: rack, 502: computer, 1101: circuit diagram, 1102: circuit diagram, 1103: circuit diagram, and 1104: circuit diagram.

1. A search system comprising:
an input portion configured to input first circuit diagram information to a terminal;
a database in which second circuit diagram information is registered;
a processing portion configured to convert the input first circuit diagram information into a first graph;
an arithmetic portion configured to calculate similarity between the first graph and a second graph based on the second circuit diagram information; and
a display portion configured to display the similarity on the terminal.

2. The search system according to claim 1, further comprising a server connected to the terminal via a network, wherein the database is stored in the server.

3. The search system according to claim 1, wherein the first circuit diagram information is a circuit element included in a circuit diagram.

4. The search system according to claim 1, wherein the first circuit diagram information is text describing a circuit diagram.

5. A search method comprising the steps of:
converting first circuit diagram information input to a terminal into a first graph;
calculating similarity between the first graph and a second graph registered in a database; and
displaying the similarity on the terminal.

6. The search method according to claim 5, wherein the first circuit diagram information is a circuit element included in a circuit diagram.

7. The search method according to claim 5, wherein the first circuit diagram information is text describing a circuit diagram.
